(19) United States
(12) Patent Application Publication
(10) Pub. No.: US 2008/0107051 A1
(43) Pub. Date: May 8, 2008

(54) SYSTEM AND METHOD FOR OPERATING A PORTABLE ELECTRONIC DEVICE

(75) Inventor: Ching Sheng Chen, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/557,122

(22) Filed: Nov. 7, 2006

(51) Int. Cl. H04B 7/00; H04M 1/00

(52) U.S. Cl. 370/310; 455/552.1

(57) ABSTRACT

A method of establishing a communication connection of a wireless communication device operable in a wireless local area network and a cellular phone network is provided. A wireless communication device, having access to the wireless local area network and the cellular phone network, is also provided. A user preference parameter is provided. The wireless local area network or the cellular phone network is selected according to the user preference parameter. A new communication connection is established using the selected network.

### BACKGROUND

1. Field of the Invention

The invention relates to mobile phones, and in particular to a mobile phone capable of connecting to a WLAN (wireless local area network) and a cellular phone network and a method for operating the same.

2. Related Art

This section is intended to introduce various aspects of the art, which may be related to various aspects of the invention described and/or claimed below. This discussion is believed to be helpful in providing the reader with background information to facilitate a better understanding of the various aspects of the invention. Accordingly, it should be understood that these statements are to be read in the light of the related art, and are not as admissions of the related art.

Some mobile phones transmit voice and/or image data via a cellular phone network, such as GSM and CDMA, as well as a wireless local area network (WLAN), such as IEEE 802.11.

The cellular phone network and the WLAN have different voice transmission characteristics. For example, the cost for making a call is much higher in a cellular phone network than in a WLAN, and a voice quality of a call is generally better in a cellular phone network than in a WLAN. Therefore, a mobile phone call on either WLAN or GSM network coverage may incur different costs and different transmission qualities.

Different users may have different consideration regarding cost and quality for making a call. However, in traditional design, users are not allowed to make any choice of operating networks for making a call. A system and a method for dynamically switching between a cellular phone network and a WLAN considering user preferences are therefore needed.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention in this disclosure.

A method of establishing a communication connection of a wireless communication device operable in a wireless local area network and a cellular phone network is provided. A wireless communication device, having access to the wireless local area network and the cellular phone network, is also provided. A user preference parameter is provided. The wireless local area network or the cellular phone network is selected according to the user preference parameter. A new communication connection is established using the selected network.

Also provided is a method of network switching of a wireless communication device operable in a first network and a second network. A wireless communication device is provided, having access to the first network and the second network. A user preference parameter is provided. A first communication connection is established using the first network. It is determined whether to terminate the first communication connection and establish a second communication connection using the second network according to the user preference parameter. The first communication connection is terminated and the second communication connection is established using the second network.

Also provided is a portable electronic device operable in a wireless local area network and a cellular phone network. The portable electronic device comprises a communication device, a storage device, and a controller. The communication device has access to the wireless local area network and the cellular phone network. The storage device stores a user preference parameter. The controller selects the wireless local area network or the cellular phone network according to the user preference parameter, and establishes a communication connection using the selected network.

Also provided is a portable electronic device operable in a first network and a second network. The portable electronic device comprises a communication device, a storage device, and a controller. The communication device has access to the first network and the second network. The storage device stores a user preference parameter. The controller establishes a first communication connection using the first network, determines whether to terminate the first communication connection and establish a second communication connection using the second network according to the user preference parameter, and terminate the first communication connection and establish the second communication connection using the second network.

### BRIEF DESCRIPTION OF DRAWINGS

The invention can be more fully understood by reading the subsequent detailed description and examples with references made to the accompanying drawings, wherein:

FIG. 1 is a schematic view of an embodiment of a communication system;

FIG. 2 is a flowchart of an embodiment of a method of network switching for a mobile phone;

FIGS. 3A, 3B, 3C and 3D are flowcharts of various embodiments of a method of network switching for a mobile phone;

FIGS. 4A and 4B are flowcharts of various embodiments of a method of network switching for a mobile phone during a connection session; and

FIG. 5 is a schematic view of a block diagram of an embodiment of a portable electronic device operable in a wireless local area network and a cellular phone network of FIG. 1.

### DETAILED DESCRIPTION OF THE PREFERRED EMBODIMENTS

One or more specific embodiments of the invention are described below. In an effort to provide a concise description of these embodiments, not all features of an actual implementation are described in the specification. It should be appreciated that in a development of any actual implementation, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

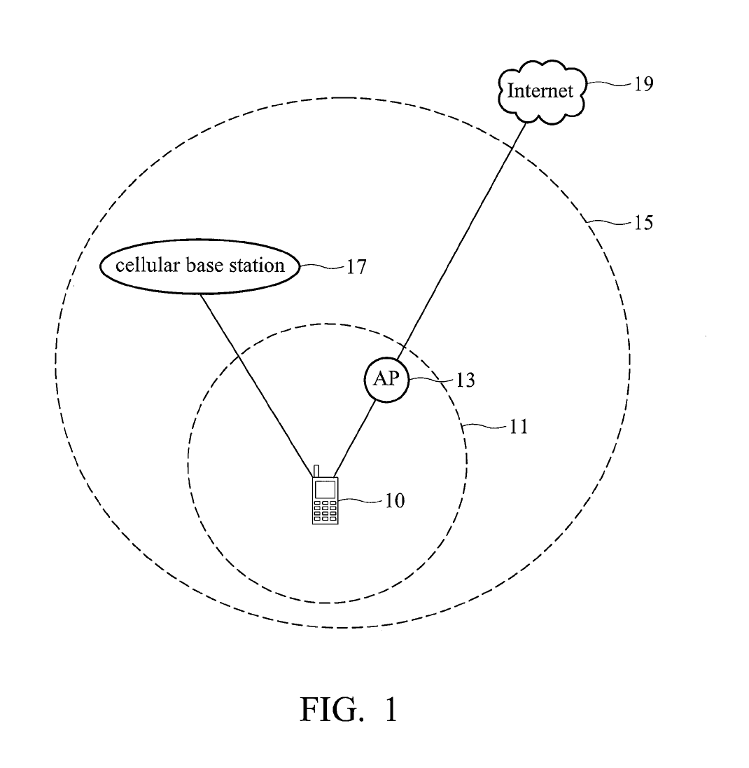

The invention is now described with reference to FIGS. 1 to 4, which generally relate to controlling a mobile phone. In the following detailed description, references are made to accompanying drawings which form a part hereof, shown by way of illustrations of specific embodiments. These embodiments are described in sufficient detail to enable persons skilled in the art to practice the invention, and it is to be understood that other embodiments may be utilized and that structural, logical and electrical changes may be made without departing from the spirit and scope of the present invention. The following detailed description is, therefore, not to be taken in a limiting sense. It should be understood that many of elements described and illustrated throughout the specification are functional in nature and may be embodied in one or more physical entities or may take other forms beyond those described or depicted.

An exemplary embodiment of network switching is performed in view of a user preference, taking account of communication and movement status of a corresponding communication device, as well as preset the user preference for network switching.

Using FIG. 1 as an example, a mobile phone 10 having access to a wireless local area network (WLAN) 11 and a cellular phone network 15 is provided. The WLAN 11 can be accessed via an access point (AP) 13 connecting to an Internet 19. The cellular phone network 15 can be accessed via a cellular base station 17. When the mobile phone 10 operates in the WLAN 11, a phone call is placed thereby using the WLAN 11 to take advantage of reduced cost. A WLAN access point has a unique ID identified by the mobile phone 10. On the other hand, when the mobile phone 10 operates outside of WLAN 11 and in the cellular phone network 15, a phone call is placed thereby using the cellular phone network 15.

This invention provides a method and system enabling users make choice of operating networks (for example, the WLAN 11 and the cellular phone network 15) for making a call using the mobile phone 10. Users can select the operating networks via setting “user preference parameters”, the method is detailed below.

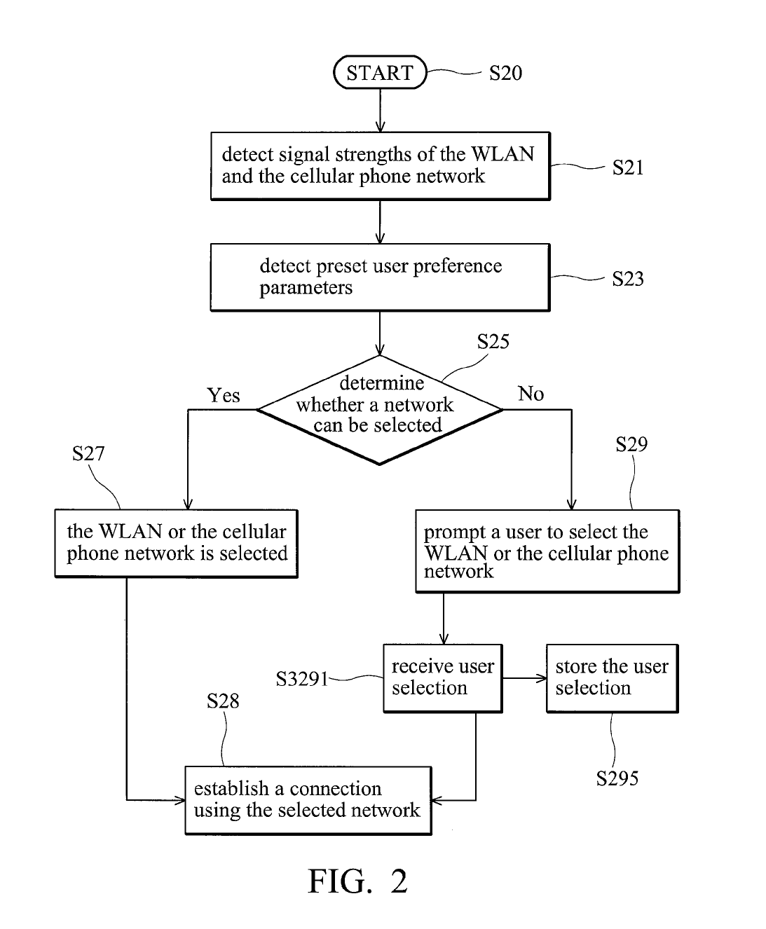

Referring to FIG. 2, a flowchart of an embodiment of a method of network switching for a mobile phone is illustrated. The method can be implemented in mobile phone 10 of FIG. 1. As described above, the mobile phone 10 has both access to WLAN 11 and a cellular phone network 15. In a start step S20, a call is to be initiated by the mobile phone 10. In a step S23, preset user preference parameters are detected. The user preference parameters can be relevant to the identity of receivers corresponding to connection of a phone call, signal strengths of the WLAN 11 and the cellular phone network 15, identification information of an access point of the WLAN 11, and/or movement status of the mobile phone 10. For example, a user preference parameter can specify a particular receiver as “an important person”. When a phone call toward the receiver is to be placed, the cellular phone network 15 is utilized. Accordingly, phone calls toward the important person specified in the user preference parameter can enjoy a better voice quality by establishing a connection for the phone call over the cellular phone network 15. For example, a user preference parameter can specify limits for signal strengths of the WLAN 11 and the cellular phone network 15, respectively. A phone call will not be placed using the WLAN 11 when the signal strength of the WLAN 11 is lower than the limit. Similarly, a phone call will not be placed using the cellular phone network 15 when the signal strength of the cellular phone network 15 is lower than the limit for signal strength thereof. In a step S25, it is determined whether a network can be selected according to the user preference parameters and current connection information, and if so, the method proceeds to a step S27, otherwise, to a step S29. Here, the current connection information includes the detected signal strengths, and the receiver of the call. In the step S27, the WLAN 11 or the cellular phone network 15 is selected for placing the call. In a step S28, a connection for the phone call is established using the selected network. In the step S29, a pop-up window prompts a user to select the WLAN 11 or the cellular phone network 15 for connection establishment. In a step S291, a user selection is received. In a step S295, the user selection is stored with the current connection information. The stored user selection and the current connection information serve as a user preference parameter.

The flowchart of FIG. 2 varies for different user preference parameters.

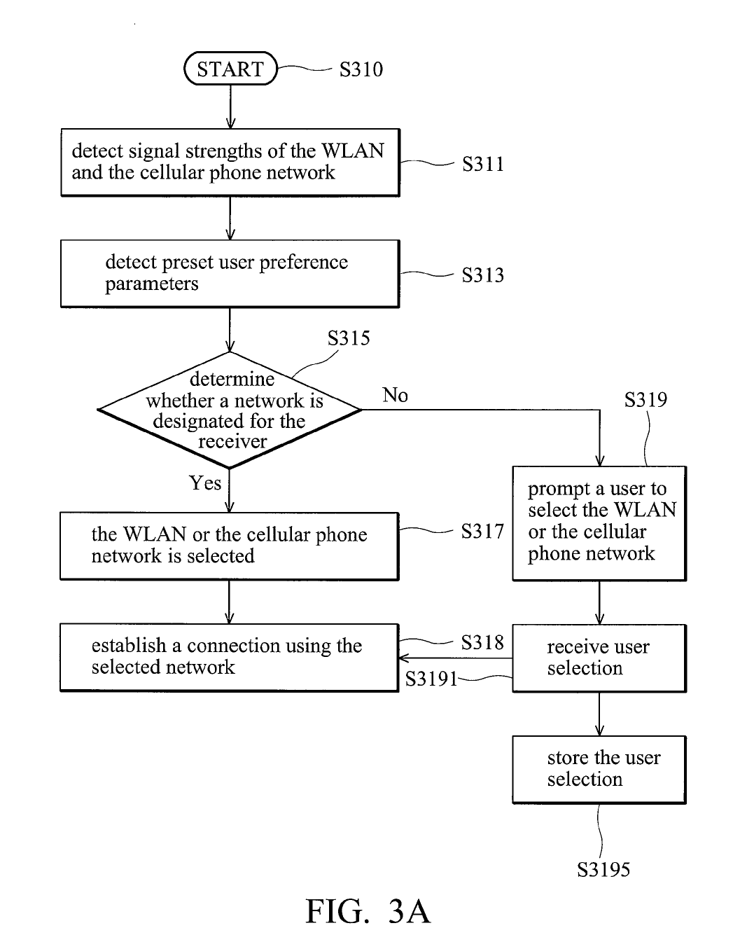

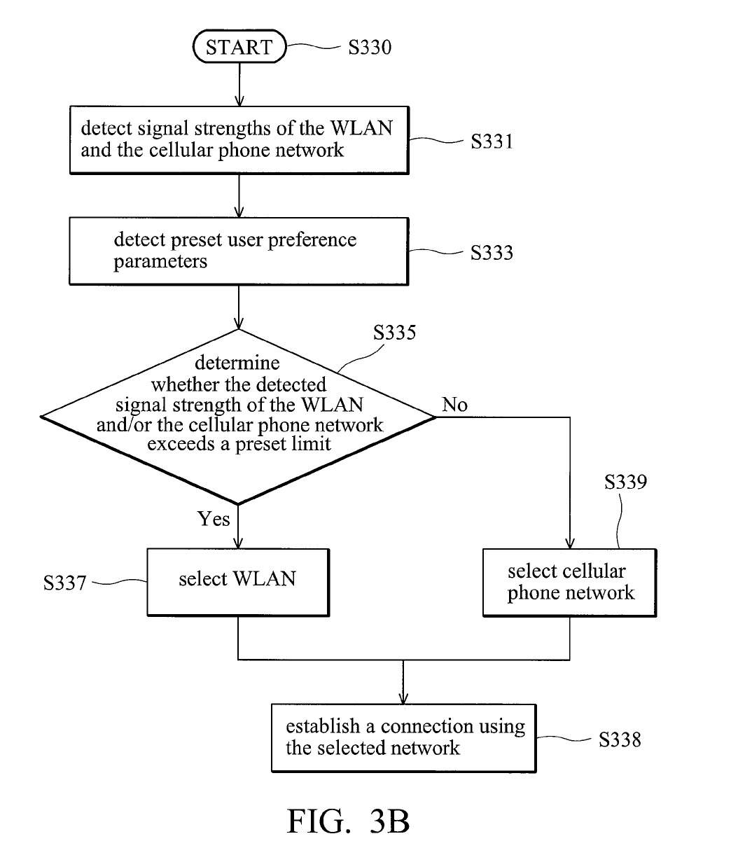

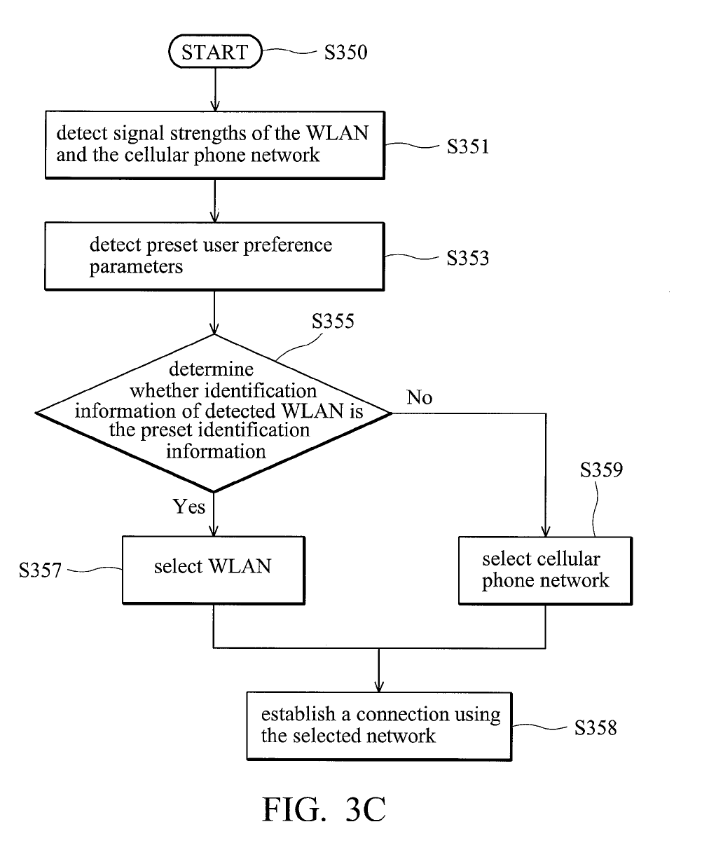

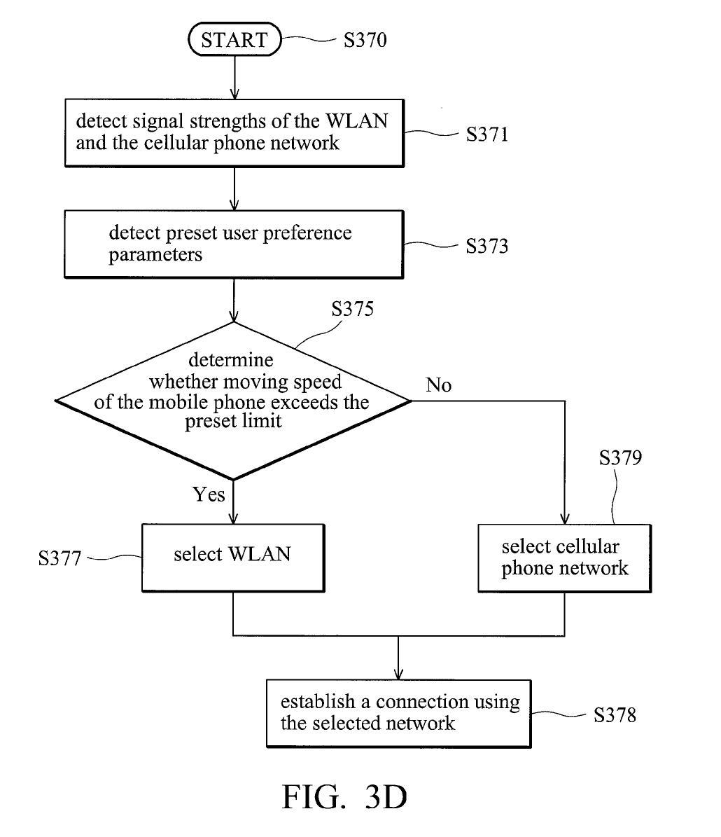

As described above, the user preference parameters can be relevant to the identity of receivers corresponding to connection. FIG. 3A illustrates operation of the method of FIG. 2 when the user preference specifies that a particular network is used to place a call to a preset receiver. In a start step S310, a call is to be placed to a receiver via a mobile phone having accesses to a WLAN and a cellular phone network. In a step S311, signal strengths of the WLAN and the cellular phone network are detected. In a step S313, a preset user preference parameter is detected. In a step S315, it is determined whether a network is designated for the receiver, and if so, the method proceeds to a step S317, otherwise, to a step S319. Here, the preset user preference parameter specifies that a particular network is used to place a call to a preset receiver. For example, for a receiver regarded as important, the cellular phone network can be designated for establishing a connection. A higher voice quality is obtained via the connection established by the cellular phone network, and a higher communication fee is incurred. On the other hand, for a receiver regarded as unimportant, the WLAN can be designated for establishing a connection. A lower voice quality is obtained via the connection established by the WLAN, and a lower communication fee is incurred. In a step S317, the WLAN or the cellular phone network is selected for placing the call. In a step S318, a connection is established using the selected network. In a step S319, a pop-up window prompts a user to select the WLAN or the cellular phone network to establish a connection. In a step S3191, a user selection is received. In a step S3195, the user selection is stored with current connection information. The stored user selection and the current connection information serve as a user preference parameter. When a call is next placed to the same receiver, a connection is established according to the stored user selection. This user preference can be recorded in a phonebook of the mobile phone 10 with a phone number corresponding to the preset receiver. In this embodiment, whenever a call is to be placed to this preset receiver, a particular network (such as a WLAN or a cellular phone network), if accessible, is used to place the call.

As described above, the user preference parameters can specify signal strengths of the WLAN 11 and the cellular phone network 15. FIG. 3B illustrates operation of the method of FIG. 2 when the user preference specifies critical signal strengths of the wireless local area network 11 and the cellular phone network 15. In a start step S330, a call is to be placed using a mobile phone having accesses to a WLAN and a cellular phone network. In a step S331, current signal strengths of the WLAN and the cellular phone network are detected. In a step S333, a preset user preference parameter is detected. The user preference parameter specifies limits for signal strengths of the WLAN 11 and the cellular phone network 15, respectively. According to the user preference parameter, a phone call will not be placed using WLAN 11 when the signal strength of WLAN 11 is lower than the limit. Similarly, a phone call will not be placed using cellular phone network 15 when the signal strength of the cellular phone network 15 is lower than the limit. In a step S335, it is determined whether the detected signal strength of the WLAN 11 and/or the cellular phone network 15 exceeds a preset limit for signal strength, and if so, the method proceeds to a step S337, otherwise, to a step S339. Here, the communication fee is higher in the cellular phone network than in the WLAN. For the sake of cost efficiency, the user preference parameter specifies that if the signal strength of the WLAN exceeds a preset limit, the WLAN is used for connection establishment. In the step S337, the WLAN is selected for placing the call. In a step S338, a connection is established using the selected network. In the step S339, the cellular phone network is selected for connection establishment.

As described above, the user preference parameters can specify identification information of an access point of the WLAN 11. FIG. 3C illustrates operation of the method of FIG. 2 when the user preference specifies identification information of an access point of the WLAN 11. In a start step S350, a call is to be placed to a receiver using a mobile phone having accesses to a WLAN and a cellular phone network. In a step S351, signal strengths of the WLAN and the cellular phone network are detected. In a step S353, a preset user preference parameter is detected. In step S355, it is determined whether identification information of the detected WLAN is preset identification information, and if so, the method proceeds to a step S357, otherwise, to a step S359. Here, the user preference parameter specifies that a specific WLAN with identification information set in the user preference parameter is used to establish a connection. For example, when a mobile phone is moving through a coverage area of a WLAN, and when a call is to be placed, the mobile phone is currently situated in the coverage area of the WLAN. The WLAN, for example, is provided by a coffee shop along a street which the user is on. The identification information specified by the user preference parameter, on the other hand, corresponds to a WLAN established in an office of the user. In the step S357, the WLAN is selected for placing the call. In a step S358, a connection is established using the selected network. In the step S359, the cellular phone network is selected for connection establishment.

As described above, the user preference parameters can be relevant to movement status of the mobile phone 10. FIG. 3D illustrates operations of the method of FIG. 2 when the user preference specifies a preset limit of movement speed of the mobile phone 10. In a start step S370, a call is to be placed using a mobile phone having accesses to a WLAN and a cellular phone network. In a step S371, signal strengths of the WLAN and the cellular phone network are detected. In a step S373, a preset user preference parameter is detected. In a step S375, it is determined whether the moving speed of the mobile phone exceeds the preset limit of movement speed specified in the user preference parameter, and if so, the method proceeds to step a S377, otherwise, to a step S379. In the step S377, the WLAN is selected for placing the call. In a step S378, a connection is established using the selected network. In the step S379, the cellular phone network is selected to establish a connection. In addition, if the user is currently moving, a cellular phone network is selected rather than a WLAN, for the sake of better support while moving.

The described user preference parameters, such as those shown in FIGS. 3A˜3D, can be combined for network switching. In addition, different user preference parameters can be assigned different weighting factors for network switching. The combination and weighting factors of user preference parameters can be determined by according to requirements.

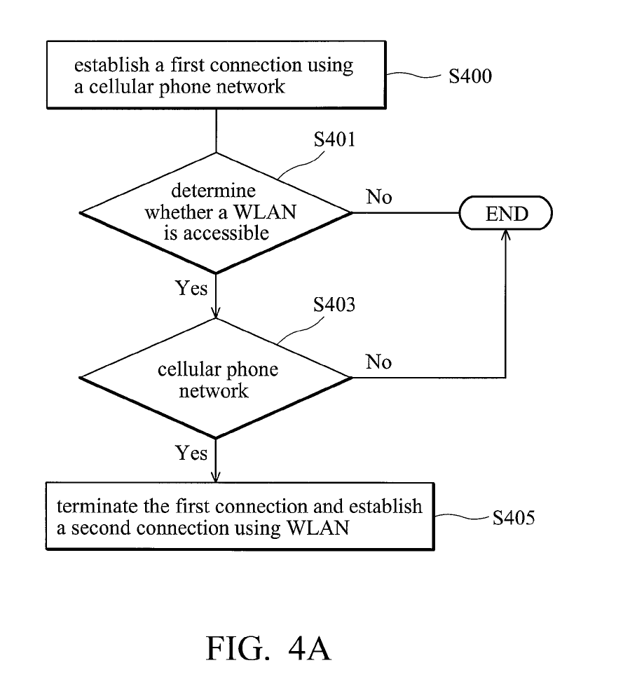

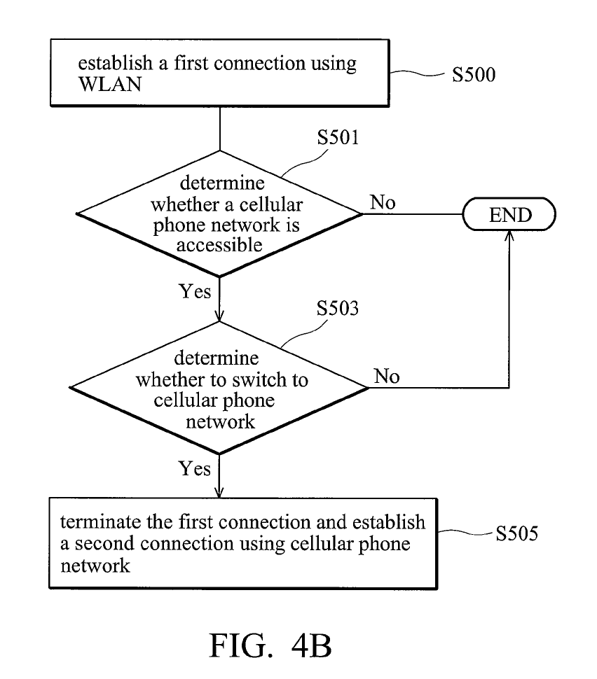

FIG. 4A illustrates a flowchart of an embodiment of a method of network switching for a mobile phone during a connection session. In a step S400, a first connection is established using a cellular phone network. Here, the mobile phone establishing the connection is in motion. For example, the user is moving across a street during the connection session. In a step S401, it is determined whether a WLAN is accessible, and if so, the method proceeds to a step S403, otherwise, the method ends. In the step S403, it is determined whether to switch to the WLAN, and if so, the method proceeds to a step S405, otherwise, the method ends.

The determination executed in step S403 can implement the described method of network switching of FIG. 2. For example, signal strengths of the WLAN and the cellular phone network are first detected, and preset user preference parameters are detected. The user preference parameters can be a receiver corresponding to connection, signal strengths of the WLAN and the cellular phone network, identification information of an access point of the WLAN, and/or movement status of the wireless communication device. It is determined whether the WLAN is selected according to the user preference parameters and current connection information, and if so, the method proceeds to step S405, otherwise, the method ends. In a step S405, the first connection is terminated, and a second connection is established automatically and immediately using the WLAN.

FIG. 4B illustrates a flowchart of another embodiment of a method of network switching for a mobile phone during a connection session. In a step S500, a first connection is established using a WLAN network. Here, the mobile phone establishing the connection is in motion. For example, the user is in an office when the call is placed, and walks out of the office during the connection session. In a step S501, it is determined whether a cellular phone network is accessible, and if so, the method proceeds to a step S503, otherwise, the method ends. In the step S503, it is determined whether to switch to the cellular phone network, and if so, the method proceeds to a step S505, otherwise, the method ends. The determination executed in the step S503 can implement the described method of network switching of FIG. 2.

For example, signal strengths of the WLAN and the cellular phone network are first detected, and preset user preference parameters are detected. The user preference parameters can be a receiver corresponding to the connection, signal strengths of the WLAN and the cellular phone network, identification information of an access point of the WLAN, and/or movement status of the wireless communication device. It is determined whether the cellular phone network is selected according to the user preference parameters and current connection information, and if so, the method proceeds to the step S505, otherwise, the method ends. In the step S505, the first connection is terminated, and a second connection is established automatically and immediately using the cellular phone network.

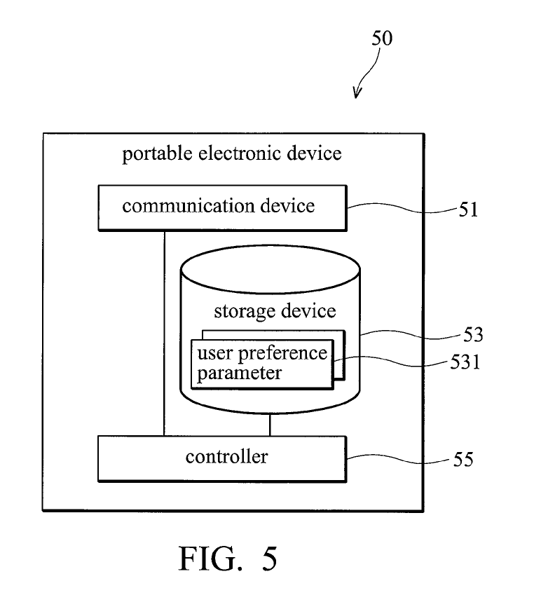

FIG. 5 is a schematic view of a block diagram of an embodiment of a portable electronic device operable in the wireless local area network 11 and the cellular phone network 15. The portable electronic device 50 comprises a communication device 51, a storage device 53, and a controller 55. The communication device 51 has access to the wireless local area network 11 and the cellular phone network 15 of FIG. 1. The storage device 53 stores a user preference parameter 531. The controller 55 selects the wireless local area network 11 or the cellular phone network 15 according to the user preference parameter, and establishes a communication connection using the selected network. The controller 55 can implement the method of FIG. 2 and FIGS. 3A˜3D.

In addition, when a communication connection has been established using the cellular phone network 15, the controller 55 can implement the method of FIG. 4A, network switching from the cellular phone network 15 to the WLAN 11 for the mobile phone 10 during a connection session is performed thereby.

In addition, when a communication connection has been established using the WLAN 11, the controller 55 can implement the method of FIG. 4B, network switching from WLAN 11 to the cellular phone network 15 for the mobile phone 10 during a connection session is performed thereby.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of establishing a communication connection of a wireless communication device operable in a wireless local area network and a cellular phone network, comprising:
providing access to the wireless local area network and the cellular phone network;
providing a user preference parameter;
selecting the wireless local area network or the cellular phone network according to the user preference parameter; and
establishing a communication connection through the selected network.

2. The method of claim 1, further comprising detecting signal strength on the wireless local area network and the cellular phone network, respectively.

3. The method of claim 2, further comprising selecting the wireless local area network or the cellular phone network according to the detected signal strength and the user preference parameter.

4. The method of claim 1, further comprising receiving a user selection designating the wireless local area network or the cellular phone network for establishing the communication connection.

5. The method of claim 4, further comprising storing the user selection as the user preference parameter.

6. The method of claim 1, wherein the user preference parameter further comprising at least one of the following: the identity of a receiver corresponding to the communication connection, signal strengths of the access to the wireless local area network and the cellular phone network, identification information of an access point of the wireless local area network, and movement status of the wireless communication device.

7. A method of network switching of a wireless communication device operable in a first network and a second network, comprising:
providing the wireless communication device having access to the first network and the second network;
providing a user preference parameter;
establishing a first communication connection using the first network;
determining whether to terminate the first communication connection and establish a second communication connection using the second network according to the user preference parameter; and
terminating the first communication connection and establishing the second communication connection using the second network.

8. A portable electronic device operable in a wireless local area network and a cellular phone network, comprising:
a communication device having access to the wireless local area network and the cellular phone network;
a storage device storing a user preference parameter; and
a controller selecting the wireless local area network or the cellular phone network according to the user preference parameter, and establishing a communication connection using the selected network.

9. The portable electronic device of claim 8, wherein the controller further detects signal strength of the wireless local area network and the cellular phone network, respectively.

10. The portable electronic device of claim 9, wherein the controller further selects the wireless local area network or the cellular phone network according to the signal strength and the user preference parameter.

11. The portable electronic device of claim 8, wherein the controller further receives a user selection designating the wireless local area network or the cellular phone network for establishing the communication connection.

12. The portable electronic device of claim 11, wherein the storage device further stores the user selection together with current connection information as the user preference parameter.

13. The portable electronic device of claim 12, wherein the current connection information comprises at least one of the following: a receiver corresponding to the communication connection, signal strength of the wireless local area network and the cellular phone network, identification information of an access point of the WLAN, movement status of the portable electronic device.

14. The portable electronic device of claim 8, wherein the user preference parameter specifies conditions in which the wireless local area network or the cellular phone network is used to establish the communication connection, wherein the conditions comprise at least one of the following: a receiver corresponding to the communication connection, signal strength of the wireless local area network and the cellular phone network, identification information of an access point of the WLAN, movement status of the portable electronic device.

15. A portable electronic device operable in a first network and a second network, comprising:
a communication device having access to the first network and the second network;
a storage device storing a user preference parameter; and
a controller establishing a first communication connection using the first network, determining whether to terminate the first communication connection and establish a second communication connection using the second network according to the user preference parameter, and terminating the first communication connection and establishing the second communication connection using the second network.
